(19) United States
(12) Patent Application Publication
(10) Pub. No.: US 2014/0313263 A1
(43) Pub. Date: Oct. 23, 2014

(54) PRINTING DEVICE

(71) Applicant: OCE-TECHNOLOGIES B.V., Venlo (NL)

(72) Inventors: Marcus J. VAN DEN BERG, Venlo (NL); Peter R. MARKIES, Grubbenvorst (NL); Johannes T. ZUILHOF, Bennekom (NL)

(21) Appl. No.: 14/318,415

(22) Filed: Jun. 27, 2014

Related U.S. Application Data
(63) Continuation of application No. PCT/EP2012/075735, filed on Dec. 17, 2012.

(30) Foreign Application Priority Data
Dec. 30, 2011 (EP) 11196178.5

(51) Int. Cl. B41J 2/14; B41J 2/16

(52) U.S. Cl. CPC B41J 2/1433; B41J 2/162
USPC 347/45; 29/890.1

(57) ABSTRACT

An ink jetprinting device includes a pressure chamber formed by a plurality of wall segments, a first aperture extending through a wall segment and communicating with an ink jet orifice and a second aperture extending through a wall segment and communicating with an ink supply duct. The pressure chamber is arranged to contain an ink composition including a carrier composition and a composition including at least one functional component. The plurality of wall segments are at least partly coated with a coating layer of a coating compound having a stronger interaction with at least one component of the carrier composition relative to the composition including the at least one functional component. A method for manufacturing such an ink-jet printing device is disclosed.

### CROSS-REFERENCE TO RELATED APPLICATIONS

This application is a Continuation of International Application No. PCT/EP2012/075735, filed on Dec. 17, 2012, and for which priority is claimed under 35 U.S.C. §120. PCT/EP2012/075735 claims priority under 35 U.S.C. §119(a) to Application No. 11196178.5, filed in Europe on Dec. 30, 2011. The entire contents of each of the above-identified applications are hereby incorporated by reference into the present application.

### BACKGROUND OF THE INVENTION

1. Field of the Invention

The present invention relates to an ink jetprinting device comprising a pressure chamber formed by a plurality of wall segments, a first aperture extending through a wall segment and communicating with an ink jet orifice and a second aperture extending through a wall segment and communicating with an ink supply duct. The present invention also relates to a printing device comprising such a pressure chamber and a method for manufacturing such a pressure chamber.

2. Description of Background Art

Ink jet systems comprising pressure chambers have long been known in the art. It is also known that for a proper operation of the ink jet system, it is preferable that the inside walls of the pressure chamber may be well wetted by the used ink composition and that the wettability by the ink composition remains constant during operation of the ink jet system. A poor wettability of the inside walls of the pressure chamber with the ink composition may easily lead to cavitations (i.e. formation of bubbles of e.g. air, or gaseous components dissolved in the ink composition) when a sub-atmospheric pressure is generated in the pressure chamber during operation. Usually a good wettability may be obtained when the surface energy of the inner walls of the pressure chamber is above the surface energy of the ink composition.

It is known to provide the inside walls of a pressure chamber with a coating which may be well wetted by the used ink composition. Such a coating may also provide a constant wettability during the printing process. In general, wetting coatings have poor anti-stick properties. Therefore solid particulate material present in the ink composition (e.g. dirt, abrasion grit from the printhead parts, pigment particles, solid ink components such as dispersed polymer particles, etc) tend to stick to the inner surface of the pressure chamber and may therefore disturb the hydrodynamics (also referred to as acoustics) inside the pressure chamber of the printing device. These disturbances may for example lead to a disturbed drop-formation process (e.g. smaller droplets due to partly blocked nozzles) and/or a disturbed jetting process (e.g. angle errors due to partly blocked nozzles), which may eventually lead to an inferior print quality.

In U.S. Pat. No. 4,947,184 it is disclosed that in order to inhibit the formation of air-bubbles during an ink jet operation, an ink jet system has a pressure chamber connected to an ink jet orifice and communicating with an ink supply duct in which the surface of the pressure chamber is coated with a layer of polymeric material providing a smooth, continuous surface conforming to the configuration of the chamber walls, which is wettable by the ink used in the system. Preferably, the coating material has a low affinity for dirt or solid particulate material that may be contained in the ink. To assure wetting by the ink used in the system, the coating should have a surface energy higher than that of the ink. Such polymeric wetting coatings provide a very smooth coated surface by filling all gaps, cracks and pinholes of the surface and therewith reduce the total surface area of the inside walls of the pressure chamber.

The paradox of a wetting coating being “sticky” and an anti-wetting coating having good anti-stick properties traditionally requires an optimization of the wetting behavior of a surface, which is in general reduced in favor of improving the anti-stick properties of the surface.

### SUMMARY OF THE INVENTION

It is an object of the present invention to provide an ink-jet printing device comprising a pressure chamber having inner walls being well wettable by an ink composition and having good anti-stick properties.

This object is at least partly achieved by providing an ink jetprinting device, comprising:
a pressure chamber formed by a plurality of wall segments;
a first aperture extending through a wall segment and communicating with an ink jet orifice; and
a second aperture extending through a wall segment and communicating with an ink supply duct,

wherein the pressure chamber is arranged to contain an ink composition comprising a carrier composition and a composition comprising at least one functional component, and wherein the plurality of wall segments are at least partly coated with a coating layer of a coating compound having a stronger interaction with at least one component of the carrier composition relative to the composition comprising the at least one functional component.

This causes the coated surface to be well wetted with the at least one component of the carrier composition, and the coating provides anti-stick properties with respect to solid particulate material present in the ink composition.

The coating layer may comprise a reaction product of a surface material of the plurality of wall segments of the pressure chamber and a coating compound comprising functional groups having a stronger interaction with the at least one component of the carrier composition relative to the composition comprising the at least one functional component.

The stronger interaction of the coated inner surface of the pressure chamber with the at least one component of the carrier composition relative to the composition comprising the at least one functional component causes the coated surface to be well wetted with the at least one component of the carrier composition. The at least one functional component may comprise colorants, such as dyes and/or dispersed pigments, solid particulate material such as polymer particles, which may be dispersed in the carrier composition. Said at least one functional component and in particular dispersed pigments and solid particulate material is substantially prevented from adhering to the coated surface and remains part of the main flow through the pressure chamber.

The carrier composition may comprise, dependent of the type of ink being used: a solvent such as water and/or organic solvents, in case of water or solvent based inks; binder resins and/or crystalline base materials, in case of hotmelt inks (also termed phase change inks).

An additional advantage of an ink jetprinting device according to the present invention is that the coating may also provide anti-stick properties with respect to solid particulate material that may accidently be present in the ink composition, such as dirt and/or abrasion grit originating from the printhead parts and/or ageing products present in the ink composition (e.g. agglomerates, decomposition products, hydrolysis products, etc).

In an embodiment, the coating layer may be a reaction product of a surface material of the plurality of wall segments of the pressure chamber and a coating compound having the following general formula:

A-B—C formula 1

wherein:

A represents a reactive group, the reactive group being reactive with a surface material of the plurality of wall segments;

B represents an optional bridging group; and

C represents a functional group providing a stronger interaction with at least one component of the carrier composition relative to the composition comprising the at least one functional component.

The stronger interaction with the at least one component of the carrier composition relative to the (entire) composition comprising the at least one functional component provides a preferential interaction with a first component of the ink composition comprised in the carrier composition relative to other components in the ink composition.

In an embodiment, the surface material of the plurality of wall segments may, at least partly, comprise silicon, silicon oxide or silicon nitride. The reactive group A of the coating compound may be selected from the group consisting of silane groups, alkene groups and derivatives of silane groups and alkene groups, the reactive group providing a covalent chemical bond with the silicon, silicon oxide or silicon nitride surface material. If the reactive group A is an alkene group or a derivative thereof, the surface material of the plurality of wall segments may also comprise silicon carbide.

The coating compound may be part of a coating composition further comprising other reactive and/or inert compounds.

### Reactive Groups

In an embodiment, the coating compound may comprise a silane compound, having a silane group as reactive group A, the coating compound having the following general formula:

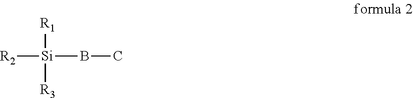

wherein:

R₁, R₂ and R₃ may independently from one another be selected from:
a first group consisting of hydrogen (—H), fluorine (—F), chlorine (—Cl), bromine (—Br), iodine (—I), and alkoxy groups comprising between 1 and 6, preferably between 1 and 4 carbon atoms; and/or
a second group comprising inert groups such as optionally substituted alkyl groups, preferably having between 1 and 6, more preferably between 1 and 4 carbon atoms; and/or
a third group consisting of —B—C groups,

wherein at least one of R₁, R₂ and R₃ is selected from the first group, and

wherein B and C represent the previously discussed optional bridging group and functional group respectively.

This embodiment comprises coating compounds having a general structure as shown in formula 2 having at least one substituent selected from the first group, which substituent provides reactivity to the compound with the surface material of the plurality of wall segments. At most, two of the groups R₁, R₂ and R₃ may be selected from the second and/or the third groups. The second group comprises inert groups. The third group consists of —B—C groups, which are bridging groups (—B—) and functional groups (—C) as defined in the present application. In other words, the silane coating compound (formula 2) may comprise at most 3 —B—C groups. However, one —B—C group is preferred. In the context of the present invention, the bridging group —B— is always optional.

Examples of alkoxy groups are methoxy (CH₃O—) and ethoxy (CH₃CH₂O—); Examples of substituted alkyl groups are —CH₂Cl, —CHCl₂ and —CCl₃

The silane reactive group (group A in formula 1) may for example be selected from the group consisting of H₃Si—, ClH₂Si—, Cl₂HSi—, Cl₃Si—, (CH₃)H₂Si—, (CH₃)ClHSi—, (CH₃)Cl₂Si—, (CH₂Cl)H₂Si—, (CHCl₂)H₂Si—, (CCl₃)H₂Si—, (CH₂Cl)ClHSi—, (CHCl₂)ClHSi—, (CCl₃)ClHSi—, (CH₂Cl)Cl₂Si—, (CHCl₂)Cl₂Si—, (CCl₃)Cl₂Si—, trimethoxy silane and triethoxy silane. Preferably trichlorosilane (C₁₃—Si—), trimethoxy silane ((CH₃O)₃—Si—) or triethoxy silane ((CH₃CH₂O)₃—Si—) groups are used as reactive group A.

In an embodiment, the coating compound may comprise an alkene compound having an alkene group as reactive group A, according to the following general formula:

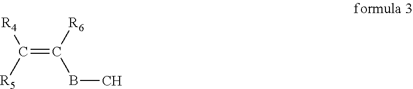

wherein:

R₄ and R₅ may be independently of one another selected from the group consisting of —H and alkyl groups having between 1 and 3 carbon atoms (i.e. methyl (—CH₃), ethyl (—CH₂CH₃) and propyl (—CH₂CH₂CH₃ or —CH(CH₃)₂);

R₆ may be selected the group consisting of —H, alkyl groups having between 1 and 10 carbon atoms (including methyl (—CH₃), ethyl (—CH₂CH₃) and propyl (—CH₂CH₂CH₃ or —CH(CH₃)₂—CH₃) and —B—C groups; and

B and C represent the previously discussed bridging group and functional group respectively.

In a preferred embodiment, at least one of R₄ and R₅ is —H. In a more preferred embodiment both R₄ and R₅ are —H. In an even more preferred embodiment R₄, R₅ and R₆ are —H.

Alkene compounds represented by formula 3 generally have to be activated to start a reaction with the surface. The activation may be obtained with radiation, in particular UV-radiation, optionally in the presence of an initiator and/or catalyst.

In an embodiment, the plurality of wall segments may be provided with a patterned coating layer. A patterned coating layer may be obtained by applying a layer of an alkene coating compound according to formula 3 onto at least a part of the surface of the plurality of wall segments and irradiating the thus coated surface in a desired pattern, for example by using a mask which mask comprises translucent regions according to the desired pattern, such that the applied layer of the alkene coating compound may be irradiated in the desired pattern. The described surface reaction with the alkene compound will only occur at the irradiated parts resulting in a patterned coating layer. A pattern may also be created by using multiple radiation beams that form an interference pattern.

### Bridging Groups

In the context of the present invention, bridging groups are optional.

Bridging groups B may be used to create a certain distance between a reactive group A and a functional group C. Bridging groups may also be used to tune the properties of the coating compound, such as surface tension and polarity.

In an embodiment, the bridging group B may comprise an alkane group preferably having between 1 and 10, more preferably between 2 and 5 carbon atoms. The alkane may be linear or branched and comprise heteroatoms. The degree of branching of the bridging group should however not be too high, because it might cause steric hindrance towards neighboring reactive surface sites and may thus lead to incomplete occupancy of the surface with the coating compound.

In an embodiment, the bridging group B may comprise a linear alkane group, preferably not comprising heteroatoms. When the bridging group comprises a linear alkane group having more than 10 carbon atoms in the chain, the molecules may easily bend, such that an optimal surface occupancy with molecules may not be obtained. Bending of the molecules may also lead to ineffectiveness of the coating layer, because the functional groups C may not be optimally positioned to optimally interact with the first component of the ink composition.

In an embodiment, the bridging group B may comprise a linear group comprising between 1 and 5 ether groups. Examples of such groups are linear groups comprising between 1 and 5 monomeric units selected from the group consisting of ethylene oxide (EO; —CH₂CH₂—O—), propylene oxide (PO; —CH(CH₃)CH₂—O— or —CH₂—CH(CH₃)—O—) and tetramethylene oxide (—CH₂CH₂CH₂CH₂—O—). In this embodiment the bridging groups comprising more than one of the above mentioned monomeric units may be obtained by oligomerization or polymerization of ethylene glycol, propylene glycol and tetrahydrofuran, respectively. Preferably, the bridging group B comprises less than 10 atoms in the chain. In case ethylene oxide units and/or propylene oxide units are used to form a bridging group, the bridging group preferably comprises between 1 and 3 monomeric units, because the total number of atoms in the chain then is 3, 6 or 9. In case tetramethylene oxide groups are used to form a bridging group, the bridging group preferably comprises 1 or 2 monomeric units, because the total number of atoms in the chain is then 5 or 10. When the bridging group comprises more than 10 atoms in the chain, the molecules may easily bend, such that an optimal surface occupancy with molecules may not be obtained. Bending of the molecules may also lead to ineffectiveness of the coating layer, because the functional groups C may not be optimally positioned to optimally interact with the first component of the ink composition.

### Functional Groups

The selection of functional groups C depends on the specific ink jet system. For a given ink jet system, i.e. water based (latex) ink jet, UV-curable ink-jet, hotmelt ink jet and the like, functional groups C may be selected that provide a stronger interaction with at least one component of the carrier composition relative to the composition comprising at least one functional component, such that the coated surface may be well wetted with the at least one component of the carrier composition of the respective ink composition.

The functional group C may have a similar chemical structure than the at least one component of the carrier composition of the ink composition. For example, the functional group C may be a group that is similar to a group present in a binder resin or crystalline base material of a hotmelt ink composition. The stronger interaction of the coating layer with the at least one component of the carrier composition of the ink composition is then based on the chemical similarity of the coated surface and the binder. The ink composition, in the present example being a hotmelt ink composition comprises a carrier composition comprising a binder resin (for example a mixture of reaction products of di-isopropanol-amine, benzoic acid and succinic acid) and/or crystalline base material (for example 1,6-bis(methoxybenzoyloxy)hexane).

The coated surface according to this embodiment provides low contact angles with the ink composition and is substantially inert towards solid particulate material present in the hot-melt composition at jetting temperature. In particular, the coated surface provides contact angles with a hotmelt ink composition in the range of 0°-90°, preferably in the range of 0°-70°, more preferably in the range of 0°-50°. Ultimately, the coated surface may provide an extremely wettable surface for a hotmelt composition, i.e. the coated surface may provide a contact angle with a hotmelt composition of 0° and a surplus of spreading energy.

In an embodiment, the functional group C may be selected from the group consisting of para-dialkyl benzenes and para-alkyl alkoxy benzenes. Such groups show chemical similarity with end groups of the binder and/or crystalline base material present in the hotmelt ink composition.

In an embodiment, the surface material of the plurality of wall segments at least partly comprise silicon, silicon oxide or silicon nitride which are at least partly coated with p-(methylphenethyl)methyldichlorosilane. The coated surface according to this embodiment may provide an extremely wettable surface for a hotmelt composition comprising a mixture of reaction products of di-isopropanol-amine, benzoic acid and succinic acid as a binder and/or 1,6-bis(methoxybenzoyloxy)hexane as a crystalline base material. With such a hotmelt composition, the coated surface may provide a contact angle of 0° and a surplus of spreading energy.

For water or solvent based ink-jet systems, the stronger interaction between the coated surface and the at least one component of the carrier composition of the ink composition (i.e. water and/or an organic solvent), may be based on (strong) interactions between the coated surface and water and/or the solvent, such as charge induced interactions, dipole interaction, hydrogen-bridge formation and the like. The functional group C may be selected accordingly.

In an embodiment, the functional group C comprises a zwitter-ion. Zwitter-ionic compounds are compounds wherein the molecules bear a positive and a negative charge at different locations (i.e. at different atoms) in the molecule. Zwitter-ionic compounds are often referred to as inner salts and are different from dipoles.

Zwitter-ions may have a strong interaction with the at least one component of carrier composition of the ink composition, i.e. with a polar solvent, such as water or small (i.e. having a low molecular weight) alcohols. The strong interaction between zwitter-ionic coatings and the polar solvent (preferably water) in combination with hydrogen-bridge formation, may provide a strongly bonded water layer on the coated surface which may have a thickness in the order of nanometers, which water layer may be substantially impermeable with respect to solid particulate material present in the ink composition. Therefore, pigment particles, dispersed polymer particles as well as dirt and other contaminants that may be present in the ink composition such as abrasion grit from the printhead parts are prevented from reaching the coated surface. The coated surface according to this embodiment provides low contact angles with the water and/or solvent based ink composition, in particular, the contact angle is in the range of 0°-90°, preferably in the range of 0°-70°, more preferably in the range of 0°-50°.

In an embodiment, the functional group C has a general formula selected from:

—X⁺-D-Y⁻ formula 4

and

—Y⁻-D-X⁺ formula 5

wherein:

X⁺ represents a cationic atom or group of atoms;

Y⁻ represents an anionic atom or group of atoms; and

D represents a spacer group.

In an embodiment, X⁺ may be a quaternary ammonium cation.

In an embodiment, Y⁻ may be selected from the group consisting of sulphate (SO₃⁻) and phosphate (PO₃⁻).

In an embodiment, the functional group represented by formula 4 is preferred. Coatings comprising such functional groups bear a negative charge at an outer layer of the coated surface. Many known solid contaminants that may be present in the ink composition tend to be also negatively charged and will be repelled by such a coating, thus providing excellent non stick properties.

In an embodiment, the spacer D may be a linear alkane group comprising between 1 and 10, preferably between 2 and 7, more preferably between 3 and 5 carbon atoms.

In an embodiment, the functional group C may be represented by the following formula:

—N⁺(CH₃)₂—C₃H₆—SO₃⁻ formula 6

In an embodiment, the surface material of the plurality of wall segments at least partly comprise silicon, silicon oxide or silicon nitride which are at least partly coated with a compound comprising a functional group represented by formula 6. When the reactive group A is an alkene group, the surface material of the plurality of wall segments may also comprise silicon carbide.

In an embodiment, the coating layer may be a mono-layer, and when the coating compound is a silane compound a self-assembling mono-layer.

### Ink-Jet Printing Device

The ink-jet printing device according to the present invention may further comprise an orifice plate, comprising a plurality of ink jetorifices, each orifice being in fluid connection with the pressure chamber and being arranged to expel droplets of the ink composition, the ink composition comprising a carrier composition and a composition comprising at least one functional component, as earlier described in the present application. The orifice plate may for example be made of silicon. Conventionally the orifice plate may be provided with a generally non-wetting outer surface, for example by coating the silicon surfaced with a fluorinated alkyl silane self assembled monolayer (e.g. with (tridecafluoro-1,1,2,2-tetrahydrooctyl)trichlorosilane). However, for similar reasons as stated earlier, it is preferred that the inside surface of the plurality of ink jetorifices may be well wettable by the ink composition and have anti-stick properties. Therefore, the orifice plate, according to the present invention, may be at least partly coated with a layer of a compound having a stronger interaction with the at least one component of the carrier composition of the ink composition relative to the composition comprising the at least one functional component.

In an embodiment, at least the inside surface of the plurality of ink-jet orifices may be coated with a layer of a compound having a stronger interaction with the at least one component of the carrier composition of the ink composition relative to the composition comprising the at least one functional component. In this embodiment the inside surface of the plurality of ink jetorifices may be well wetted with the ink composition which is advantageous because the risk of cavitations, i.e. the risk of formation of bubbles of, e.g. air, or gaseous components dissolved in the ink composition and/or sucking in of ambient air when a sub-atmospheric pressure is generated in the pressure chamber during operation, is significantly reduced.

Another advantage of the present embodiment is that the inside of the narrow orifice passages have a low affinity towards solid particulate material that may disturb the drop formation process.

In an embodiment, the outer surface of the orifice plate may be made anti-wetting in a region directly adjacent to the orifices, in particular an anti-wetting gradient may be provided in that region. Ink droplets that have landed on the outer surface of the orifice plate may be transported away from the orifices, such that said droplets do not disturb the jetting process. Outside said region, the outer surface of the orifice plate may be made wetting by providing a coating according to the present invention. An advantage of the present embodiment is that the outer surface of the orifice plate may have a low affinity towards solid particulate material as defined in the present application (i.e. the outer surface has good anti-stick properties). Therefore, upon drying of the ink composition present on the orifice plate, solid particulate material may be prevented from adhering to the outer surface of the orifice plate and dried ink residues comprising said solid particulate material may be easily wiped off the outer surface of the orifice plate.

In an embodiment, the coating compound may have a general formula as represented by formula 1, wherein A, B and C may have the previously stated meaning.

In an embodiment, the functional group C may be selected from the group consisting of para-dialkyl benzenes and para-alkyl alkoxy benzenes.

In an embodiment, the functional group C may have a general formula represented by formula 4 or 5, wherein X⁺, D and Y⁻ have the previously stated meaning. Preferably the functional group has a general formula as represented by formula 4, for the previously stated reason.

In this embodiment, the orifice plate is at least partly provided with a coating comprising zwitter ions, which may have a strong interaction with the at least one component of the carrier composition of the ink composition, i.e. with a polar solvent, such as water or small (i.e. having a low molecular weight) alcohols. The orifice plate surface may have a wetting outer surface for example for water borne ink compositions, such as a latex ink composition. During printing, a thin film of ink may be formed on the coated parts of the orifice plate. Due to the stronger interaction with the at least one component of the carrier composition of the ink composition, in case water, adherence of solid particulate material present in the ink to the surface of the orifice plate may be prevented. Ink residues present on the orifice plate may therefore be easily wiped off the outer surface of the orifice plate.

The ink-jet printing device according to the present invention may further comprise an actuator arranged for providing a pressure response in the pressure chamber in order to expel droplets of the ink composition through the ink jet orifice.

### Method for Manufacturing an Ink-Jet Printing Device Comprising a Coating According to the Present Invention

It is known to form an ink-jet printing device based on etching a functional structure in an etchable layer of material, such as silicon, wherein a fluid (ink or any other suitable fluid) to be ejected from the inkjet print head flows through at least part of such functional structure. Moreover, usually such manufacturing includes processing of multiple layers in order to obtain the desired functional structure.

When applying multiple layers, such layers may be preprocessed separately and after preprocessing be bonded to form the desired functional structure. It is known to bond the separate layers by application of a suitable adhesive.

In another aspect of the present invention there is provided for a method for manufacturing an ink-jet printing device according to the present invention comprising the steps of:

a. providing and preprocessing a plurality of layers of a suitable material;

b. bonding the plurality of layers to obtain a functional structure, comprising a pressure chamber formed by a plurality of wall segments and arranged to contain an ink composition comprising a first component and a second component, the functional structure further comprising a first aperture extending through a wall segment and communicating with an ink jet orifice and a second aperture extending through a wall segment and communicating with an ink supply duct;

c. providing a coating compound having a reactive group A; and

d. reacting the coating compound with at least a part of the surface of the plurality of wall segments to form a coating layer,

wherein the resulting ink jetprinting device comprises a pressure chamber being arranged to contain an ink composition comprising a carrier composition and a composition comprising at least one functional component, and wherein the resulting coating layer may have a stronger interaction with the at least one component of the carrier composition of the ink composition relative to the at least one functional component.

In an embodiment, at least a part of a surface of the plurality of wall segments may be reacted with the coating compound prior to bonding the plurality of layers to form the functional structure.

In an embodiment, the coating compound may have a general formula as represented by formula 1, wherein:

A represents a reactive group, the reactive group being reactive with a surface material of the plurality of wall segments;

B represents an optional bridging group; and

C represents a functional group providing the preferential interaction with the first component of the ink composition.

In an embodiment, the coating compound may be a precursor compound comprising a first reactive group A′, an optional first bridging group B′ and a second reactive group E, the optional first bridging group being arranged between the first reactive group A′ and the second reactive group E, the method further comprises the steps of:

e. providing a reactant comprising a third reactive group F, being able to react with the second reactive group E, an optional second bridging group B″ and a functional group C, the optional second bridging group being arranged between the third reactive group F and the functional group C; and

f. reacting the reactant with the precursor compound present on at least a part of the surface of the plurality of wall segments,

wherein the first bridging group B′, the second bridging group B″ and the reaction product of the second reactive group E and the third reactive group F form the bridging group B according to formula 1.

The first reactive group A′ may be selected from the group consisting of the previously described reactive groups A.

In a further embodiment, the second reactive group may be shielded with at least one shielding group S, in order to prevent the second reactive group to react with the first reactive group A′ and/or with the surface of the plurality of wall segments. The shielding group may therefore be inert with respect to the first reactive group A′ and the surface of the plurality of wall segments. In this embodiment, the method comprises the additional step of removing the shielding group, which may be performed prior to step d.

In an embodiment, the reactive group A or the first reactive group A′ may be a silane group as shown in formula 2. In this embodiment, the reaction step may comprise an initiation step, for example applying heat.

In an embodiment, the reactive group may comprise an alkene group as shown in formula 3. In this embodiment, the reaction step d may comprise an initiation step. The initiation step may comprise applying radiation, preferably UV radiation, optionally in the presence of an initiator and/or a catalyst.

In an embodiment, the method may comprise the additional step of applying a mask to the at least part of the surface of the plurality of wall segments, prior to applying radiation in the initiation step. The mask may comprise a pattern of regions that are transparent with respect to the radiation and regions that are non-transparent, in accordance with a desired coating pattern.

In an embodiment, the functional group C may be (further) modified by reacting the coating layer being formed in one of the previously described embodiments with one or more reactants in one or more steps.

In an embodiment, the method for manufacturing an ink jetprinting device further comprises the steps of:

g. contacting the functional structure with a fluorinated organic trichloro silane (FOTS), in particular with (tridecafluoro-1,1,2,2-tetrahydrooctyl)trichlorosilane, such that at least a part of the surface of the functional structure reacts with the FOTS, the functional structure also comprising an orifice plate;

h. at least partly covering the outer surface of the orifice plate with a cover, in particular with a mask, the cover may comprise pattern covering regions of the outer surface of the orifice plate;

i. etching the functional structure as obtained in step h, preferably by oxygen plasma etching; and

j. removing the cover,

wherein the consecutive steps g-j are performed prior to step c.

In this embodiment, the functional structure as obtained in step b including an orifice plate is first coated with FOTS (step g), which is an anti-wetting coating. By at least partly covering the outer surface of the orifice plate in step h, the covered parts of the surface are protected from being etched in step i. The FOTS coating may thus be provided in a pattern on the outer surface of the orifice plate, by applying a patterned mask to the outer surface of the orifice plate, for example to create an anti-wetting gradient in the vicinity of the plurality of orifices. After etching, the uncovered parts of the surface of the functional structure including the orifice plate—which uncovered parts are then substantially free from FOTS—the cover, is removed. In the remainder of the process steps (i.e. b and c or b-f), at least a part of the etched part of the surface of the functional structure including the orifice plate may be coated with a coating according to the present invention, which has wetting and anti-stick properties. It has surprisingly been found that regions of the surface of the functional structure including the orifice plate that are covered with FOTS after step j are not coated with a coating according to the present invention. In this embodiment, a generally anti-wetting coating (FOTS) may be combined with a wetting and anti-stick coating on a single surface.

Thus the present invention at least relates to:

According to a first aspect of the present invention, an ink jetprinting device comprising:

a pressure chamber formed by a plurality of wall segments;

a first aperture extending through a wall segment and communicating with an ink jet orifice; and

a second aperture extending through a wall segment and communicating with an ink supply duct,

wherein the pressure chamber is arranged to contain an ink composition comprising a carrier composition and a composition comprising at least one functional component, and wherein the plurality of wall segments are at least partly coated with a coating layer of a coating compound having a stronger interaction with at least one component of the carrier composition relative to the composition comprising the at least one functional component, which causes the coated surface to be well wetted with the at least one component of the carrier composition, and wherein the coating provides anti-stick properties with respect to solid particulate material present in the ink composition.

According to a second aspect of the present invention, the coating layer comprises a reaction product of a surface material of the plurality of wall segments of the pressure chamber and a compound having the following general formula:

A-B—C formula 1

wherein:

A represents a reactive group, the reactive group being reactive with a surface material of the plurality of wall segments;

B represents an optional bridging group; and

C represents a functional group providing the stronger interaction with at least one component of the carrier composition relative to the composition comprising the at least one functional component.

According to a third aspect of the present invention, the functional group C is selected from the group consisting of para-dialkyl benzenes and para-alkyl alkoxy benzenes.

According to a fourth aspect of the present invention, the surface material of the plurality of wall segments at least partly comprise silicon, silicon oxide or silicon nitride which are at least partly coated with p-(methylphenethyl)methyldichlorosilane.

According to a fifth aspect of the present invention, the functional group C comprises a zwitter-ion having a general formula selected from:

—X⁺-D-Y⁻ formula 4

and

—Y⁻-D-X⁺ formula 5

wherein:

X⁺ represents a cationic atom or group of atoms;

Y⁻ represents an anionic atom or group of atoms;

D represents a spacer group.

According to a sixth aspect of the present invention, the functional group C is represented by the following formula:

—N⁺(CH₃)₂—C₃H₆—SO₃⁻ formula 6

According to a seventh aspect of the present invention, the surface material of the plurality of wall segments at least partly comprises silicon, silicon oxide or silicon nitride and the reactive group A of the coating compound is selected from the group consisting of silane groups, alkene groups and derivatives of silane groups and alkene groups, the reactive group providing a chemical bond with the silicon, silicon oxide or silicon nitride surface material.

According to a eighth aspect of the present invention, the coating compound comprises a silane compound, having a silane group as reactive group A, the coating compound having the following general formula:

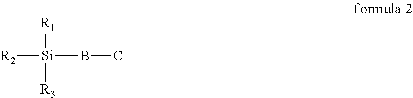

wherein:
R₁, R₂ and R₃ are independently from one another being selected from:

a first group consisting of hydrogen (—H), fluorine (—F), chlorine (—Cl), bromine (—Br), iodine (—I), and alkoxy groups comprising between 1 and 6 carbon atoms; and/or

a second group comprising inert groups comprising optionally substituted alkyl groups; and/or

a third group consisting of —B—C groups, and

at least one of R₁, R₂ and R₃ is selected from the first group.

According to a ninth aspect of the present invention, the coating compound comprises an alkene compound having an alkene group as reactive group A, according to the following general formula:

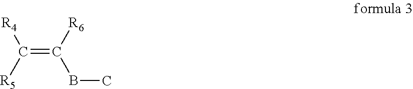

wherein:

R₄ and R₅ may be independently of one another selected from the group consisting of —H and alkyl groups having between 1 and 3 carbon atoms; and

R₆ may be selected the group consisting of —H, alkyl groups having between 1 and 10 carbon atoms and —B—C groups.

According to an tenth aspect of the present invention, R₄, R₅ and R₆ are —H.

According to a eleventh aspect of the present invention, the plurality of wall segments are provided with a patterned coating layer.

According to a twelfth aspect of the present invention, the bridging group B comprises a linear alkane having between 1 and 10 carbon atoms.

According to a thirteenth aspect of the present invention, the ink-jet printing device further comprises an orifice plate, comprising a plurality of ink-jet orifices, each orifice being in fluid connection with the pressure chamber and being arranged to expel droplets of the ink composition, the orifice plate being at least partly coated with a layer of a compound having a stronger interaction with the at least one component of the carrier composition of the ink composition relative to the composition comprising the at least one functional component.

According to the present invention, a method for manufacturing the ink jet printing device according to the present invention comprises the steps of:

a. providing and preprocessing a plurality of layers of a suitable material;

b. bonding the plurality of layers to obtain a functional structure, comprising a pressure chamber formed by a plurality of wall segments and arranged to contain an ink composition comprising a first component and a second component, the functional structure further comprising a first aperture extending through a wall segment and communicating with an ink jet orifice and a second aperture extending through a wall segment and communicating with an ink supply duct;

c. providing a coating compound having a reactive group A; and

d. reacting the coating compound with at least a part of the surface of the plurality of wall segments to form a coating layer,

wherein the resulting ink jetprinting device comprises a pressure chamber being arranged to contain an ink composition comprising a carrier composition and a composition comprising at least one functional component; and wherein the resulting coating layer may have a stronger interaction with the at least one component of the carrier composition of the ink composition relative to the at least one functional component.

According to an embodiment of the method according to the present invention, the coating compound comprises a precursor compound comprising a first reactive group A′, an optional first bridging group B′ and a second reactive group E, the optional first bridging group being arranged between the first reactive group A′ and the second reactive group E, the method further comprises the steps:

e. providing a reactant comprising a third reactive group F, being able to react with the second reactive group E, an optional second bridging group B″ and a functional group C, the optional second bridging group being arranged between the third reactive group F and the functional group C; and

f. reacting the reactant with the precursor compound present on at least a part of the surface of the plurality of wall segments,

wherein the first bridging group B′, the second bridging group B″ and the reaction product of the second reactive group E and the third reactive group form the bridging group B according to formula 1.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a perspective view of an image forming apparatus applying an inkjet print head for providing an image on an image receiving member;

FIG. 1B is a perspective view of a schematical representation of an embodiment of an inkjet process;

FIG. 2 is a schematical cross-section of an embodiment of an ink-jet printing device;

FIG. 3 schematically illustrates a section of an ink jetprinting device coated with a compound having a preferential interaction with a first component of an ink composition;

FIG. 4 illustrates a reaction scheme for applying a coating according to an embodiment of the present invention; and

FIG. 5 illustrates a reaction scheme for applying a coating according to an embodiment of the present invention (derived from: Ai T. Nguygen et al., Langmuir 2011, 27, 2587-2594).

### DETAILED DESCRIPTION OF THE PREFERRED EMBODIMENTS

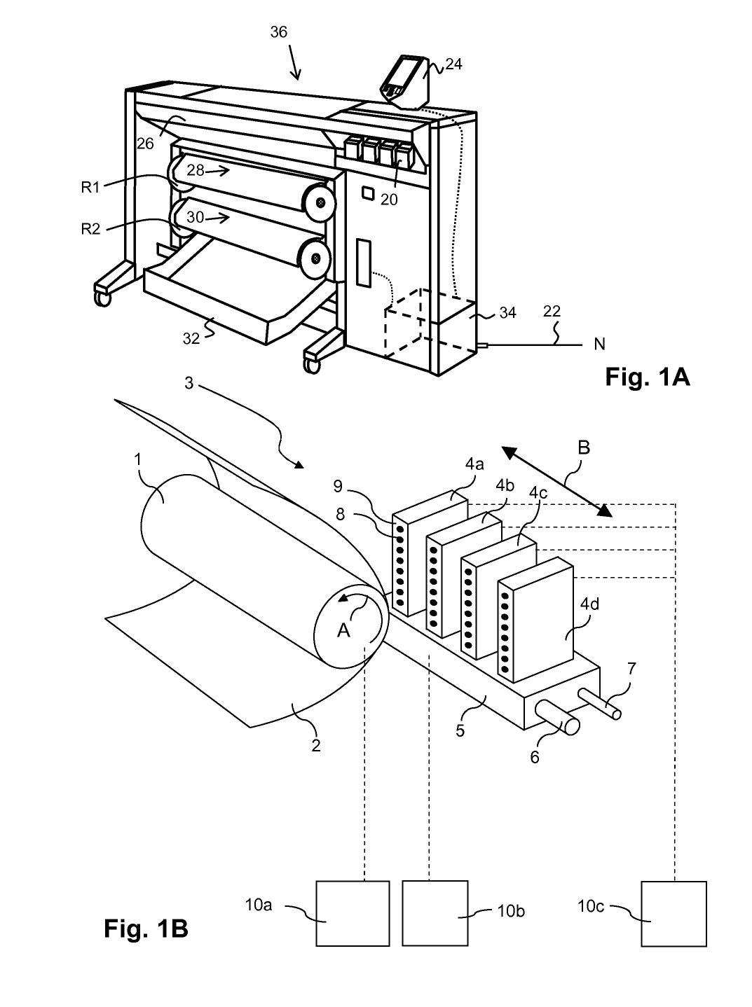

FIG. 1A illustrates an image forming apparatus 36, wherein printing is achieved using a wide format inkjet printer. The wide-format image forming apparatus 36 comprises a housing 26, wherein the printing assembly, for example the ink jet printing assembly shown in FIG. 1B is placed. The image forming apparatus 36 also comprises a storage device configured to store image receiving member 28, 30, a delivery station to collect the image receiving member 28, 30 after printing and a storage device for marking material 20. In FIG. 1A, the delivery station is embodied as a delivery tray 32. Optionally, the delivery station may comprise a processor for processing the image receiving member 28, 30 after printing, e.g. a folder or a puncher. The wide-format image forming apparatus 36 furthermore comprises a device configured to recieve print jobs and optionally a device configured to manipulate print jobs. These devices may include a user interface unit 24 and/or a control unit 34, for example a computer.

Images are printed on an image receiving member, for example paper, supplied by a roll 28, 30. The roll 28 is supported on the roll support R1, while the roll 30 is supported on the roll support R2. Alternatively, cut sheet image receiving members may be used instead of rolls 28, 30 of image receiving member. Printed sheets of the image receiving member, cut off from the roll 28, 30, are deposited in the delivery tray 32.

Each one of the marking materials for use in the printing assembly are stored in four containers 20 arranged in fluid connection with the respective print heads for supplying marking material to said print heads.

The local user interface unit 24 is integrated to the print engine and may comprise a display unit and a control panel. Alternatively, the control panel may be integrated in the display unit, for example in the form of a touch-screen control panel. The local user interface unit 24 is connected to a control unit 34 placed inside the printing apparatus 36. The control unit 34, for example a computer, comprises a processor adapted to issue commands to the print engine, for example for controlling the print process. The image forming apparatus 36 may optionally be connected to a network N. The connection to the network N is diagrammatically shown in the form of a cable 22, but nevertheless, the connection could be wireless. The image forming apparatus 36 may receive printing jobs via the network. Further, optionally, the controller of the printer may be provided with a USB port, so printing jobs may be sent to the printer via this USB port.

FIG. 1B shows an ink jet printing assembly 3. The ink jet printing assembly 3 comprises a support for supporting an image receiving member 2. The support is shown in FIG. 1B as a platen 1, but alternatively, the support may be a flat surface. The platen 1, as depicted in FIG. 1B, is a rotatable drum, which is rotatable about its axis as indicated by arrow A. The support may be optionally provided with suction holes for holding the image receiving member in a fixed position with respect to the support. The ink jet printing assembly 3 comprises print heads 4a-4d, mounted on a scanning print carriage 5. The scanning print carriage 5 is guided by suitable guiding means 6, 7 to move in reciprocation in the main scanning direction B. Each print head 4a-4d comprises an orifice surface 9, which orifice surface 9 is provided with at least one orifice 8. The print heads 4a-4d are configured to eject droplets of marking material onto the image receiving member 2. The platen 1, the carriage 5 and the print heads 4a-4d are controlled by suitable controls 10a, 10b and 10c, respectively.

The image receiving member 2 may be a medium in web or in sheet form and may be composed of e.g. paper, cardboard, label stock, coated paper, plastic or textile. Alternatively, the image receiving member 2 may also be an intermediate member, endless or not. Examples of endless members, which may be moved cyclically, are a belt or a drum. The image receiving member 2 is moved in the sub-scanning direction A by the platen 1 along four print heads 4a-4d provided with a fluid marking material.

A scanning print carriage 5 carries the four print heads 4a-4d and may be moved in reciprocation in the main scanning direction B parallel to the platen 1, such as to enable scanning of the image receiving member 2 in the main scanning direction B. Only four print heads 4a-4d are depicted for demonstrating the invention. In practice, an arbitrary number of print heads may be employed. In any case, at least one print head 4a-4d per color of marking material is placed on the scanning print carriage 5. For example, for a black-and-white printer, at least one print head 4a-4d, usually containing black marking material is present. Alternatively, a black-and-white printer may comprise a white marking material, which is to be applied on a black image-receiving member 2. For a full-color printer, containing multiple colors, at least one print head 4a-4d for each of the colors, usually black, cyan, magenta and yellow is present. Often, in a full-color printer, black marking material is used more frequently in comparison to differently colored marking material. Therefore, more print heads 4a-4d containing black marking material may be provided on the scanning print carriage 5 compared to print heads 4a-4d containing marking material in any of the other colors. Alternatively, the print head 4a-4d containing black marking material may be larger than any of the print heads 4a-4d, containing a differently colored marking material.

The carriage 5 is guided by guides 6, 7. These guides 6, 7 may be rods as depicted in FIG. 1B. The rods may be driven by suitable drives (not shown). Alternatively, the carriage 5 may be guided by other guides, such as an arm being able to move the carriage 5. Another alternative is to move the image receiving material 2 in the main scanning direction B.

Each print head 4a-4d comprises an orifice surface 9 having at least one orifice 8, in fluid communication with a pressure chamber containing fluid marking material provided in the print head 4a-4d. On the orifice surface 9, a number of orifices 8 is arranged in a single linear array parallel to the sub-scanning direction A. Eight orifices 8 per print head 4a-4d are depicted in FIG. 1B, however obviously in a practical embodiment several hundreds of orifices 8 may be provided per print head 4a-4d, optionally arranged in multiple arrays. As depicted in FIG. 1B, the respective print heads 4a-4d are placed parallel to each other such that corresponding orifices 8 of the respective print heads 4a-4d are positioned in-line in the main scanning direction B. This means that a line of image dots in the main scanning direction B may be formed by selectively activating up to four orifices 8, each of them being part of a different print head 4a-4d. This parallel positioning of the print heads 4a-4d with corresponding in-line placement of the orifices 8 is advantageous to increase productivity and/or improve print quality. Alternatively multiple print heads 4a-4d may be placed on the print carriage adjacent to each other such that the orifices 8 of the respective print heads 4a-4d are positioned in a staggered configuration instead of in-line. For instance, this may be done to increase the print resolution or to enlarge the effective print area, which may be addressed in a single scan in the main scanning direction. The image dots are formed by ejecting droplets of marking material from the orifices 8.

Upon ejection of the marking material, some marking material may be spilled and stay on the orifice surface 9 of the print head 4a-4d. The ink present on the orifice surface 9, may negatively influence the ejection of droplets and the placement of these droplets on the image receiving member 2. Therefore, it may be advantageous to remove excess of ink from the orifice surface 9. The excess of ink may be removed for example by wiping with a wiper.

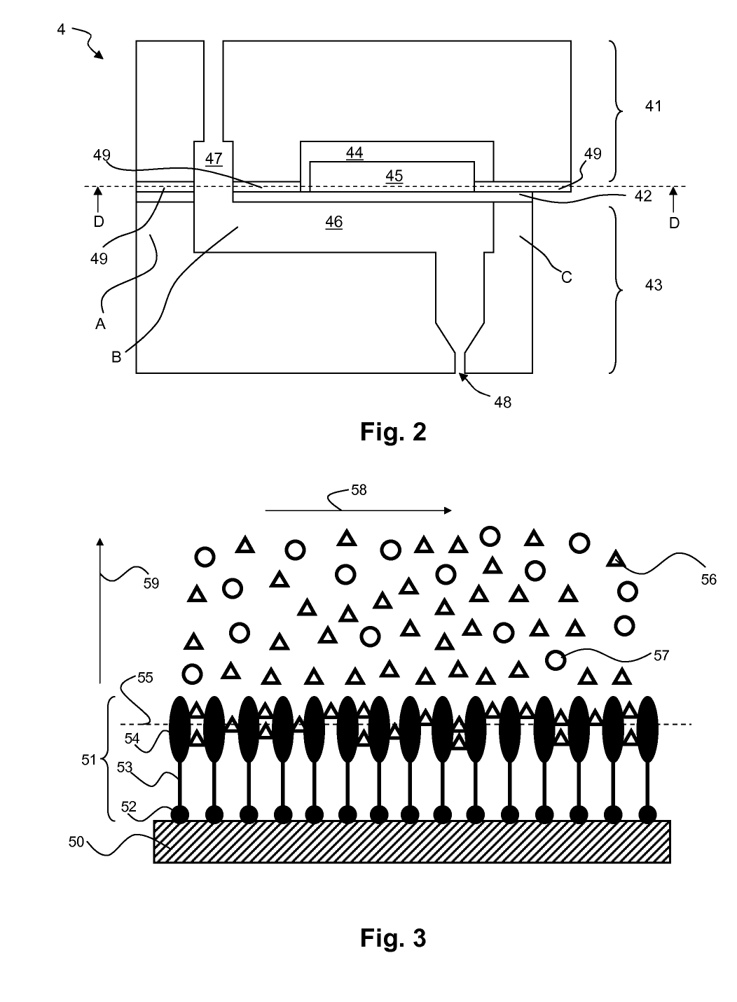

FIG. 2 illustrates an embodiment of a print head 4 in more detail. The print head 4 is assembled from three layers of material: a first layer 41 having arranged therein a fluid channel 47 and an actuator cavity 44; a second layer 42 having arranged thereon a piëzo actuator 45 and provided with a through hole to extend the fluid channel 47; and a third layer 43 having arranged therein a pressure chamber 46 and a corresponding nozzle 48. A bonding layer 49 provides bonding of the first layer 41 and the second layer 42.

The print head 4 is configured to receive a fluid such as ink through the fluid channel 47. The fluid fills the pressure chamber 46. Upon supply of a suitable drive signal to the piëzo actuator 45, a pressure wave is generated in the pressure chamber 46 resulting in a droplet of fluid being expelled through the nozzle 48.

The illustrated print head 4 may be manufactured from silicon, in particular lithographic methods and etching methods may be employed to form the first, second and third layers from silicon wafers. Thus, a compact and cost-efficient print head 4 may be manufactured. While the fluid to be expelled through the nozzle 48, such as an ink, flows through the fluid channel 47, the pressure chamber 46 and the nozzle 48, it is desirable to prevent that any fluid may arrive in the actuator cavity 44 and thus may reach the actuator 45, since the efficiency and thereby the lifetime of the piëzo actuator 45 is negatively influenced by fluid, moisture, and the like.

In order to prevent that the fluid reaches the piëzo actuator, it is known to use an impermeable adhesive to bond the first layer 41 and the second layer 42.

FIG. 3 is a schematic representation of a section of an ink-jet printing device coated with a compound having a preferential interaction with a first component of an ink composition. The section may be any part of the printing device and in particular the inside walls of the pressure chamber (46 in FIG. 2) and/or the inside surface of the plurality of orifices and/or at least a part of the outside surface of the orifice plate.

FIG. 3 shows a surface 50 which is coated with a compound 51 comprising a reactive group 52 (group A in formula 1) which has reacted with the material of the surface 50 (e.g. Si, SiO₂, SiN and the like), a bridging group 53 (optional group B in formula 1) and a functional group 54 (group C in formula 1).

FIG. 3 also illustrates that the coating has a stronger interaction with at least one component of the carrier composition (represented by the open triangles 56) relative to the composition comprising the at least one functional component (represented by the open circles 57). The stronger interaction of the coating with the at least one component of the carrier composition causes the at least one component of the carrier composition to be preferentially present in a layer near the surface 50, as represented by line 55. The coating layer comprising compound 51 and the at least one component of the carrier composition present therein, provides a barrier which is virtually impermeable regarding solid particulate material and/or any component that may unwantedly (ir)reversibly adhere to or react with surface 50. Such material and/or components, as represented by the open circles 57, are thus prevented to reach surface 50.

Due to the stronger interaction of the coating with the at least one component of the carrier composition relative to the composition comprising the at least one functional component, a concentration gradient of solid particulate material and/or any component that may unwantedly (ir)reversibly adhere to or react with surface 50 may exist, comprising an increasing concentration of said material and/or components in the direction away from the coated surface, as indicated with arrow 59.

In case the coated surface comprises at least a part of the plurality of wall segments forming the pressure chamber (46 in FIG. 2), the solid particulate material and/or any component that may unwantedly (ir)reversibly adhere to or react with surface 50, remains part of the main flow through the ink jetprinting device as represented by arrow 58.

In case the coated surface comprises at least a part of the orifice plate, the ink residue present on the orifice plate may be easily wiped off, e.g. in the direction indicated by arrow 58, thus removing substantially all unwanted components from the surface of the orifice plate.

The coating as schematically shown in FIG. 3 therefore shows good wetting properties with the at least one component of the carrier composition and good anti-stick properties regarding solid particulate material and/or any component that may unwantedly (ir)reversibly adhere to or react with surface 50.

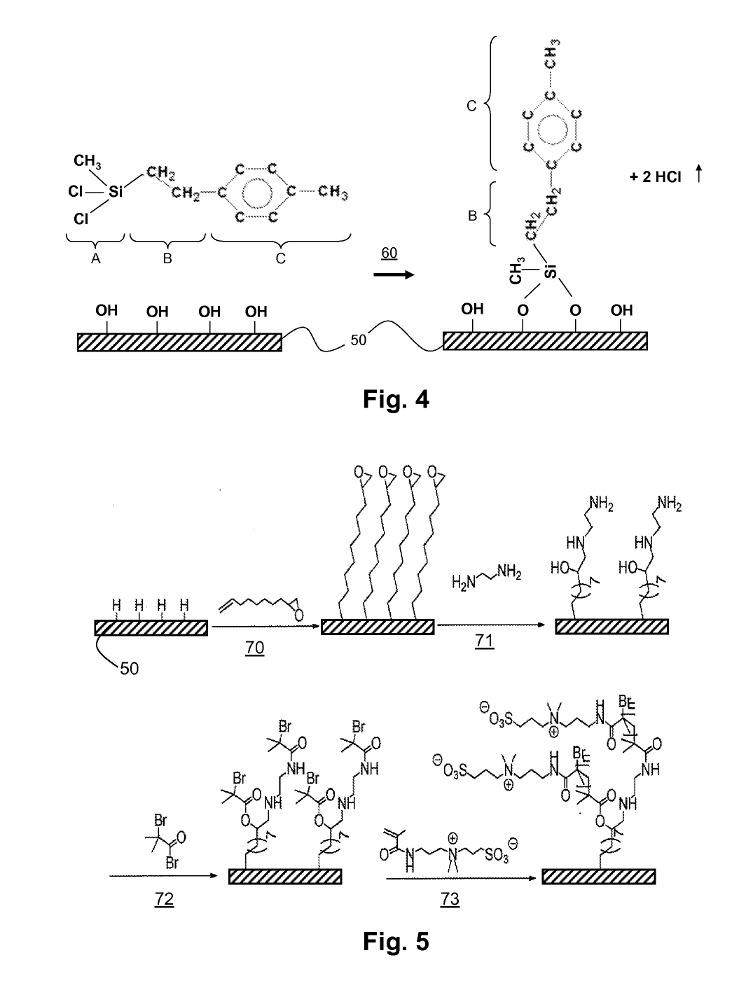

FIG. 4 illustrates a reaction scheme for applying a coating according to an embodiment of the present invention. The shown coating compound is p-(Methylphenethyl)methyldichlorosilane and comprises a reactive group A, being a methyldichlorosilane-group; a bridging group B, being a divalent ethyl group; and a functional group C, being a para-methyl-phenyl group.

The surface 50 may be the surface of an inorganic material used to build a functional structure, for example an ink jetprinting device. Examples of such inorganic materials are (but not limited to) Si, SiO₂ or SiN. Such a surface may comprise —OH groups as shown in FIG. 4. In other embodiments the surface may comprise —H.

In a single reaction step 60, preferably performed in a sub-atmospheric environment (i.e. at a pressure below 1 bar) and at room temperature, the silane groups react with the —OH surface groups in order to form covalent bonds with the surface. In the present example, hydrogen chloride (HCl) is also formed. The reaction may for example be performed in a vacuum clock or an exicator (i.e. a dessicator).

The coating compound forms a monomolecular coating layer on the surface 50.

The functional group C shows chemical similarity with a mixture of reaction products of di-isopropanol-amine, benzoic acid and succinic acid (a suitable binder for a hotmelt composition) and 1,6-bis(methoxybenzoyloxy)hexane (a suitable crystalline base material for a hotmelt composition). Therefore the coating layer shows a preferential interaction with those compounds. The coating layer has good anti-stick properties with respect to solid particulate material present in the hotmelt ink composition comprising at least one of said components, or other components comprising similar end groups.

FIG. 5 illustrates a reaction scheme for applying a coating according to an embodiment of the present invention. The reaction scheme is deduced from work done by the group of Han Zuilhof at the Laboratory of Organic Chemistry of Wageningen University (cf. Ai T. Nguygen et al., “Stable Protein-Repellent Zwitterionic Polymer Brushes Grafted from Silicon Nitride”, Langmuir, 2011, 27, 2587-2594). All chemical compounds used are commercially available.

FIG. 5 illustrates a surface 50 of parts to be coated, in particular made of an inorganic material, for example Si, SiO₂,SiN or SiC (silicon carbide). The surface 50 of the parts to be coated may be pre-processed in order to obtain a clean surface bearing —H groups on the outer surface, as shown in FIG. 5. Such pre-processing may comprise one or more of the following steps: wet cleaning, e.g. with acetone; oxidation of the surface, e.g. in an air-based plasma; etching, e.g. with an aqueous solution of HF.

In a first step 70, an alkene based precursor, in the present example 1,2-epoxy-9-decene (obtained from Sigma Aldrich at 96% purity and purified by column chromatography to a purity >99% as determined by gas chromatography/mass spectroscopy (GC-MS)), is degassed in a quartz flask. The pre-processed parts are then transferred into the quartz flask, followed by a number (e.g. 3) of vacuum-argon cycles to remove trace amounts of oxygen. Finally the flask is backfilled with argon. The surface 50 is then irradiated for 24 hrs under argon by a UV pen-lamp (254 nm, low pressure mercury vapor, double bore lamp from Jelight Company Inc., California) with an output intensity of 9 mW*cm⁻², the lamp was aligned 4 mm away from the quartz flask. The parts are then removed from the flask and sonicated in acetone for 5 min, rinsed several times with acetone and distilled petroleum ether and finally dried in a stream of argon.

In a second step 71, the parts as obtained in the first step 70 are transferred to a diamine, in the present example to degassed neat 1,2-ethylenediamine (p.a., absolute, ≧99.5% purity, obtained from Sigma Aldrich). The flask containing the parts and the 1,2-ethylenediamine is then heated to 40° C. and kept at that temperature for 24 hrs, such that a reaction between the epoxy and the diamine occurs. After ca. 24 hrs, the parts are removed from the flask and the same cleaning procedure as described in the first step is performed.

In a third step 72, the parts as obtained in the second step 71 are subjected to a surface initiated atom radical polymerization catalyst (ATRP catalyst), which is attached onto the amine terminated product obtained in the second step 71. In the present example, the obtained product is reacted with 2-bromoisobutyrylbromide (0.54 g, 2.00 mmol) in dry dichloromethane (1 mL) containing triethylamine (0.2 mL) at room temperature for 30 minutes (all obtained from Sigma Aldrich). Then the parts are removed from the flask and cleaned by sonication in dichloromethane for 5 minutes and rinsed thoroughly with acetone and distilled petroleum ether.

Hexadecyl or ethylene-oxide coated surfaces may be obtained in a similar way as the immobilization of 1,2-epoxy-9-decene as described above.

In a fourth step 73, a solution comprising poly(sulfobetaineacrylamide) (SBMAA) and 2,2′-bipyridine (bipy) in a molar ratio of 2:1 dissolved in a mixture of isopropanol (IPA) and water in a volume ratio of 3:1, wherein the total concentration of SBMAA and bipy in the solvent mixture is 0.6 mol/L is prepared in a round-bottom flask. All compounds may be obtained from Sigma Aldrich. The solution is degassed with argon for 30 minutes. In a separate round-bottom flask, CuBr is added under argon and closed by a septum. The above described solution, e.g. in an amount of 10 mL, is then transferred to the round bottom flask containing the CuBr by means of a syringe and the mixture is stirred for an additional 30 minutes. The mixture is then transferred to the flask containing the parts as obtained in the third step 72. A polymerization reaction is then carried out under argon pressure (e.g. 0.14 bar overpressure) while stirring at room temperature for 3 hrs. Finally the parts are removed from the flask and rinsed with water of a temperature between 60° C. and 65° C. for 5 minutes and cleaned by sonication in water and further with acetone. The parts are then dried under a stream of argon.

The final product comprises a surface coated with a compound comprising zwitter-ions, in the present example of the type as shown in formula 4. Such a coated surface shows a preferential interaction with polar solvents, in particular water, and prevents solid particulate materials, in particular pigments and polymer latex particles to adhere at the surface. A coating as described in the current embodiment therefore has excellent wetting properties in combination with anti-stick properties.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An ink jetprinting device, comprising:
a pressure chamber formed by a plurality of wall segments;
a first aperture extending through a wall segment and communicating with an ink jet orifice; and
a second aperture extending through a wall segment and communicating with an ink supply duct,
wherein the pressure chamber is arranged to contain an ink composition comprising a carrier composition and a composition comprising at least one functional component,
wherein the plurality of wall segments are at least partly coated with a coating layer of a coating compound having a stronger interaction with at least one component of the carrier composition relative to the composition comprising the at least one functional component, which causes the coated surface to be well wetted with the at least one component of the carrier composition, and
wherein the at least one functional component is substantially prevented from adhering to the coated surface.

2. The ink jetprinting device according to claim 1, wherein the coating layer comprises a reaction product of a surface material of the plurality of wall segments of the pressure chamber and a compound having the following general formula:
A-B—C formula 1
wherein:
A represents a reactive group, the reactive group being reactive with a surface material of the plurality of wall segments;
B represents an optional bridging group; and
C represents a functional group providing a stronger interaction with at least one component of the carrier composition relative to the composition comprising the at least one functional component.

3. The ink jetprinting device according to claim 2, wherein the surface material of the plurality of wall segments at least partly comprises silicon, silicon oxide or silicon nitride, and
wherein the reactive group A of the coating compound is selected from the group consisting of silane groups, alkene groups and derivatives of silane groups and alkene groups, the reactive group A providing a chemical bond with the silicon, silicon oxide or silicon nitride surface material.

4. The ink-jet printing device according to claim 1, wherein the coating compound comprises a silane compound, having a silane group as reactive group A, the coating compound having the following general formula: 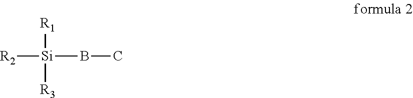
wherein:
R₁, R₂ and R₃ are independently from one another being selected from:
a first group consisting of hydrogen (—H), fluorine (—F), chlorine (—Cl), bromine (—Br), iodine (—I), and alkoxy groups comprising between 1 and 6 carbon atoms; and/or
a second group comprising inert groups comprising optionally substituted alkyl groups; and/or
a third group consisting of —B—C groups, and
wherein at least one of R₁, R₂ and R₃ is selected from the first group.

5. The ink-jet printing device according to claim 3, wherein the coating compound comprises an alkene compound having an alkene group as reactive group A, according to the following general formula: 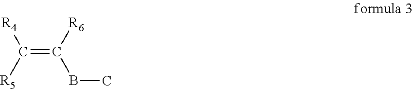
wherein:
R₄ and R₅ may be independently of one another selected from the group consisting of —H and alkyl groups having between 1 and 3 carbon atoms; and
R₆ may be selected the group consisting of —H, alkyl groups having between 1 and 10 carbon atoms and —B—C groups.

6. The ink jetprinting device according to claim 5, wherein R₄, R₅ and R₆ are —H.

7. The ink jetprinting device according to claim 5, wherein the plurality of wall segments are provided with a patterned coating layer.

8. The ink jetprinting device according to claim 2, wherein the bridging group B comprises a linear alkane having between 1 and 10 carbon atoms.

9. The ink-jet printing device according to claim 2, wherein the functional group C is selected from the group consisting of para-dialkyl benzenes and para-alkyl alkoxy benzenes.

10. The ink jetprinting device according to claim 9, wherein the surface material of the plurality of wall segments at least partly comprises silicon, silicon oxide or silicon nitride, which are at least partly coated with p-(methylphenethyl)methyldichlorosilane.

11. The ink-jet printing device according to claim 2, wherein the functional group C comprises a zwitter-ion having a general formula selected from:
—X⁺-D-Y⁻ formula 4
and
—Y⁻-D-X⁺ formula 5
wherein:
X⁺ represents a cationic atom or group of atoms;
Y⁻ represents an anionic atom or group of atoms; and
D represents a spacer group.

12. The ink jetprinting device according to claim 11, wherein the functional group C is represented by the following formula:
—N⁺(CH₃)₂—C₃H₆—SO₃⁻ formula 6

13. The ink jetprinting device according to claim 1, further comprising an orifice plate, comprising a plurality of ink jetorifices, each orifice being in fluid connection with the pressure chamber and being arranged to expel droplets of the ink composition, the orifice plate being at least partly coated with a layer of a compound having a stronger interaction with the at least one component of the carrier composition of the ink composition relative to the composition comprising the at least one functional component.

14. A method for manufacturing an ink-jet printing device as defined in claim 1, said method comprising the steps of:
providing and preprocessing a plurality of layers of a suitable material;
bonding the plurality of layers to obtain a functional structure, comprising a pressure chamber formed by a plurality of wall segments and arranged to contain an ink composition comprising a first component and a second component, the functional structure further comprising a first aperture extending through a wall segment and communicating with an ink jet orifice and a second aperture extending through a wall segment and communicating with an ink supply duct;
providing a coating compound having a reactive group A; and
reacting the coating compound with at least a part of the surface of the plurality of wall segments to form a coating layer,
wherein the resulting ink jetprinting device comprises a pressure chamber being arranged to contain an ink composition comprising a carrier composition and a composition comprising at least one functional component, and
wherein the resulting coating layer may have a stronger interaction with the at least one component of the carrier composition of the ink composition relative to the at least one functional component.

15. The method according to claim 14, wherein the coating compound comprises a precursor compound comprising a first reactive group A′, an optional first bridging group B′ and a second reactive group E, the optional first bridging group being arranged between the first reactive group A′ and the second reactive group E, said method further comprising the steps:
providing a reactant comprising a third reactive group F, being able to react with the second reactive group E, an optional second bridging group B″ and a functional group C, the optional second bridging group being arranged between the third reactive group F and the functional group C; and
reacting the reactant with the precursor compound present on at least a part of the surface of the plurality of wall segments,
wherein the first bridging group B′, the second bridging group B″ and the reaction product of the second reactive group E and the third reactive group form the bridging group B according to formula 1.
